(19) United States
(12) Patent Application Publication
(10) Pub. No.: US 2023/0211677 A1
(43) Pub. Date: Jul. 6, 2023

(54) SUPERCAPACITOR TO ELECTROCHEMICAL HYBRID TOP-OFF SYSTEM

(71) Applicant: SUSTAINABLE ENERGY TECHNOLOGIES, INC., Wilmington, DE (US)

(72) Inventor: John Cronin, Wilmington, DE (US)

(21) Appl. No.: 18/088,663

(22) Filed: Dec. 26, 2022

Related U.S. Application Data
(60) Provisional application No. 63/295,422, filed on Dec. 30, 2021.

(51) Int. Cl. B60L 53/00; B60L 50/40; B60L 50/60; H02J 7/34; H01M 10/42

(52) U.S. Cl. CPC B60L 53/00; B60L 50/40; B60L 50/60; H02J 7/345; H01M 10/4264; H01M 2220/20; H01M 2010/4278

(57) ABSTRACT

A system for powering an electric vehicle includes a first switch disposed on a first electrical path between at least one electrochemical battery and the electric vehicle, a second switch disposed on a second electrical path between at least one supercapacitor top-off battery and the electric vehicle, and a controller communicatively coupled to the first switch and the second switch, wherein the controller, responsive to a first switching condition, disconnects the at least one electrochemical battery from the electric vehicle via the first switch and connects the at least one supercapacitor top-off battery to the electric vehicle via the second switch to power the electric vehicle, wherein the at least one electrochemical battery is coupled to an generator of the electric vehicle via a third electrical path, such that the at least one electrochemical battery is recharged by the generator while the electric vehicle is powered by the at least one supercapacitor top-off battery.

### CROSS-REFERENCE TO RELATED APPLICATIONS

This application claims the benefit of U.S. Provisional Application No. 63/295,422, filed Dec. 30, 2021, for “SUPERCAPACITOR TO ELECTROCHEMICAL HYBRID TOP-OFF SYSTEM,” the disclosure of which is incorporated herein by reference in its entirety.

### TECHNICAL FIELD

The present disclosure is generally related to batteries for electric vehicles and, more particularly, to a hybrid power system for an electric vehicle incorporating supercapacitor and electrochemical batteries.

### BACKGROUND

The subject matter discussed in the background section should not be assumed to be prior art merely due to its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

The number of electric vehicles (EVs) in operation has grown exponentially in recent years. Conventionally, EVs have relied on electrochemical batteries, e.g., lithium-ion and lead-acid batteries. However, electrochemical batteries suffer from a variety of disadvantages including a short shelf-life, low peak power, and a limited number of charging/discharging cycles.

Supercapacitors are like a hybrid of an electrochemical battery and a standard capacitor. Supercapacitors can hold a significantly greater electrical charge than a standard capacitor and can be recharged many more times than electrochemical batteries. Electrochemical batteries have less energy density than supercapacitors. Energy density is measured by the energy produced divided by the weight of the battery.

Supercapacitors discharge faster than electrochemical batteries, as supercapacitors cannot hold power for a long time. Supercapacitors will discharge up to 20% more power per day than batteries of equal capacity. Supercapacitors have a fast discharged time but also have fast charging time. Electrochemical batteries take longer to charge but discharge more slowly, so they don't have to be charged as frequently as supercapacitors. Electrochemical batteries are ideal for long-term power storage needs because they discharge electricity less quickly.

Supercapacitors have a longer lifespan than electrochemical batteries. Some supercapacitors can be charged millions of times before they start to degrade. By contrast, electrochemical batteries, like lead-acid batteries, may only provide 500 to 1,000 charge cycles before they degrade.

There is a need to provide a top-off capacity using supercapacitors when electrochemical batteries cannot supply enough power to electric vehicles. There is also a need to provide a top-off capacity using supercapacitors when electrochemical batteries are drained and emergency power is needed for electric vehicles.

### SUMMARY OF THE DISCLOSURE

According to one aspect, a system for powering an electric vehicle includes at least one electrochemical battery and at least one supercapacitor top-off battery. The system also includes a first switch disposed on a first electrical path between the at least one electrochemical battery and the electric vehicle, the first switch to connect or disconnect the at least one electrochemical battery to or from the electric vehicle. The system further includes a second switch disposed on a second electrical path between the at least one supercapacitor top-off battery and the electric vehicle, the second switch to connect or disconnect the at least one supercapacitor top-off battery to or from the electric vehicle. In addition, the system includes a controller communicatively coupled to the first switch and the second switch, wherein the controller, responsive to a first switching condition, disconnects the at least one electrochemical battery from the electric vehicle via the first switch and connects the at least one supercapacitor top-off battery to the electric vehicle via the second switch to power the electric vehicle. The at least one electrochemical battery is also coupled to an generator of the electric vehicle via a third electrical path, such that the at least one electrochemical battery is recharged by the generator while the electric vehicle is powered by the at least one supercapacitor top-off battery.

In one embodiment, the system also includes at least one current tester disposed on one or more of the first electrical path or the second electrical path, the at least one current tester to measure current flow between the at least one electrochemical battery or the at least one supercapacitor top-off battery, respectively, and the electric vehicle.

In one embodiment, the first switching condition includes the current flow (or a current spike) meeting or exceeding a threshold value. The first switching condition may also include a temperature of the electric vehicle dropping below a low temperature threshold.

The system may further include a database to store real-time measurements of the current flow from the at least one current tester. The controller may calculate a current use pattern for one or both of the at least one electrochemical battery or the at least one supercapacitor top-off battery based on the real-time measurements of the current flow. In such an embodiment, the first switching condition includes a future load prediction based on the current use pattern exceeding an amount of charge remaining in one or both of the at least one electrochemical battery or the at least one supercapacitor top-off battery. The future load prediction may be obtained from machine learning according to historical current use patterns.

In some embodiments, the controller, responsive to second switching condition, disconnects the at least one supercapacitor top-off battery from the electric vehicle via the second switch and reconnects the at least one electrochemical battery to the electric vehicle via the first switch.

In another aspect, method for powering an electric vehicle is provided. The method includes providing at least one electrochemical battery and at least one supercapacitor top-off battery. The method also includes disposing a first switch on a first electrical path between the at least one electrochemical battery and the electric vehicle, the first switch to connect or disconnect the at least one electrochemical battery to or from the electric vehicle. The system further includes disposing a second switch on a second electrical path between the at least one supercapacitor top-off battery and the electric vehicle, the second switch to connect or disconnect the at least one supercapacitor top-off battery to or from the electric vehicle. In addition, the method includes controlling the first switch and the second switch, responsive to a first switching condition, to disconnect the at least one electrochemical battery from the electric vehicle via the first switch and connect the at least one supercapacitor top-off battery to the electric vehicle via the second switch to power the electric vehicle. The method also includes recharging the at least one electrochemical battery via a generator of the electric vehicle connected to the at least one electrochemical battery through a third electrical path while the electric vehicle is powered by the at least one supercapacitor top-off battery.

### BRIEF DESCRIPTION OF THE DRAWINGS

The accompanying drawings illustrate various embodiments of systems, methods, and other aspects of the embodiments. Any person with ordinary art skills will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 is a schematic diagram of a hybrid power system for an electric vehicle according to an embodiment.

FIG. 2 is a flowchart of a method performed by a base module according to an embodiment.

FIG. 3 is a flowchart of a method performed by a supercapacitor top-off controller according to an embodiment.

FIG. 4 is a block diagram illustrating a switch controlled by controller that toggles between a first configuration in which components draw power from an electrochemical battery and a second configuration in which the components draw power from a supercapacitor battery, according to an embodiment.

FIG. 5 is a block diagram illustrating use of one or more trained machine learning models of a machine learning engine to identify a power draw, for instance to estimate a current power draw or predict a future power draw, according to an embodiment.

FIG. 6 and FIG. 7 are flow charts illustrating processes for energy management performed using a control system, according to an embodiment.

### DETAILED DESCRIPTION

Aspects of the present invention are disclosed in the following description and related figures directed to specific embodiments of the invention. Those of ordinary skill in the art will recognize that alternate embodiments may be devised without departing from the claims' spirit or scope. Additionally, well-known elements of exemplary embodiments of the invention will not be described in detail or will be omitted so as not to obscure the relevant details of the invention.

As used herein, the word exemplary means serving as an example, instance, or illustration. The embodiments described herein are not limiting but rather are exemplary only. It should be understood that the described embodiments are not necessarily to be construed as preferred or advantageous over other embodiments. Moreover, the terms embodiments of the invention, embodiments, or invention do not require that all embodiments include the discussed feature, advantage, or mode of operation.

Further, many of the embodiments described herein are described in sequences of actions to be performed by, for example, elements of a computing device. It should be recognized by those skilled in the art that specific circuits can perform the various sequence of actions described herein (e.g., application-specific integrated circuits or “ASICs”) and/or by program instructions executed by at least one processor. Additionally, the sequence of actions described herein can be embodied entirely within any form of computer-readable storage medium. The execution of the sequence of actions enables the processor to perform the functionality described herein. Thus, the various aspects of the present invention may be embodied in several different forms, all of which have been contemplated to be within the scope of the claimed subject matter. In addition, for each of the embodiments described herein, the corresponding form of any such embodiments may be described herein as, for example, a computer configured to perform the described action.

For all ranges given herein, it should be understood that any lower limit may be combined with any upper limit when feasible. Thus, for example, citing a temperature range of from 5° C. to ° C. and from 20° C. to 200° C. would also inherently include a range of from 5° C. to 200° C. and a range of 20° C. to ° C.

When listing various aspects of the products, methods, or system described herein, it should be understood that any feature, element, or limitation of one aspect, example, or claim may be combined with any other feature, element, or limitation of any other aspect when feasible (i.e., not contradictory). Thus, disclosing an example of a power pack comprising a temperature sensor and then a different example of a power pack associated with an accelerometer would inherently disclose a power pack comprising or associated with an accelerometer and a temperature sensor.

Unless otherwise indicated, components such as software modules or other modules may be combined into a single module or component or divided. The function involves the cooperation of two or more components or modules. Identifying an operation or feature as a single discrete entity should be understood to include division or combination such that the effect of the identified component is still achieved.

Some embodiments of this disclosure, illustrating its features, will now be discussed in detail. It can be understood that the embodiments are intended to be open-ended in that an item or items used in the embodiments is not meant to be an exhaustive listing of such items or items or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used to practice or test embodiments, only some exemplary systems and methods are now described.

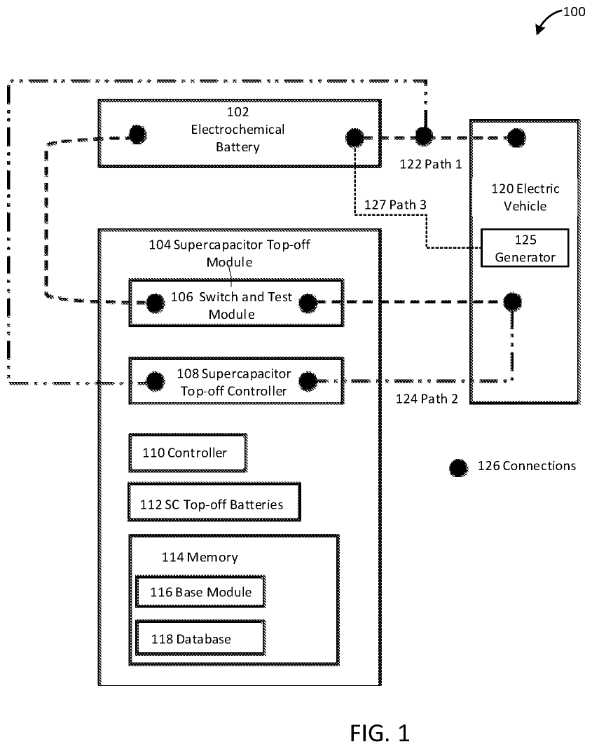

FIG. 1. is a schematic diagram of a hybrid power system 100 for an electric vehicle 120 according to an embodiment. The system 100 may include an electrochemical (EC) battery 102, such as a lead-acid battery or a lithium-ion battery. While the disclosure often refers to a singular electrochemical battery 102, it should be understood that any such reference is understood to include one or more electrochemical batteries 102. The electrochemical battery 102 may be an existing electrochemical battery 102 within the electric vehicle 120 or may be in addition to an existing electrochemical battery 102 or battery system.

The system 100 may further include a supercapacitor (SC) top-off module 104, which may be embodied as a self-contained unit with various connections 126. Although four connections 126 are illustrated in FIG. 1, a person of skill in the art will recognize that more or fewer connections 126 may be provided. The supercapacitor top-off module 104 may include one or more supercapacitor top-off batteries 112, which have a particular capacity that allows a set amount of charge to replace the electrochemical battery 102 if the electrochemical battery 102 falls below a certain threshold level. While the present disclosure often refers to the supercapacitor top-off batteries 112 in the plural, it should be understood that any such reference is understood to include one or more supercapacitor top-off batteries 112 or groups of supercapacitors or supercapacitor cells.

The supercapacitor top-off module 104 may be small enough to fit into an existing battery compartment of the electric vehicle 120. The electric vehicle 120 may be any type of electric vehicle, non-limiting examples of which include automobiles, trucks, vans, fork lifts, carts (such as golf carts or baby carts), motorcycles, electric bikes scooters, autonomous vehicles, mobile robotic devices, hoverboards, monowheels, Segways®, wheelchairs, drones, personal aircraft, robotic devices, aquatic devices (such as boats, Jet Skis®, diver propulsion vehicles or underwater scooters), or the like.

Principles for the design, manufacture, and operation of supercapacitors are described, by way of example, in U.S. Pub. No. 2019/0180949, titled “Supercapacitor,” published Aug. 29, 2017; U.S. Pat. No. 9,318,271, titled “High-Temperature Supercapacitor,” issued Apr. 19, 2016; U.S. Pub. No. 2020/0365336, titled “Energy Storage Device,” published Nov. 19, 2020; U.S. Pat. No. 9,233,860, titled “Supercapacitor and Method for Making the Same,” issued Jan. 12, 2016; and U.S. Pat. No. 9,053,870, titled “Supercapacitor with a Mesoporous Nanographene Electrode,” issued Jun. 9, 2015, all of which are incorporated herein by reference.

The supercapacitor top-off batteries 112 may include any type or configuration of supercapacitor top-off batteries or cells having enough capacity to enhance the integration of the supercapacitor top-off module 104 and the electrochemical battery 102. The supercapacitor top-off batteries 112 may be configured to have the same voltage as the electrochemical battery 102 so to easily integrate into the electric vehicle 120. In some embodiments, the supercapacitor top-off batteries 112 are designed for emergency and/or high demand needs and therefore may not be configured to run the electric vehicle 120 for extended periods.

As described in greater detail below, the supercapacitor top-off module 104 may also include a control system to automatically switch between the electrochemical battery 102 and the supercapacitor top-off batteries 112 (or vice versa) when powering the electric vehicle 120.

One reason to switch between electrochemical battery 102 and supercapacitor top-off batteries 112 is when electrochemical batteries 102 falls below a certain level of charge and there is a need to have some emergency power to power the electric vehicle 120 for a short time. Another reason for the supercapacitor top-off batteries 112 is in cold start conditions where an electrochemical battery 102 needs more energy to start a gas-powered vehicle or gas/electric hybrid vehicle. Yet another reason for switching from the electrochemical battery 102 to the supercapacitor top-off batteries 112 may be to allow the supercapacitor top-off batteries 112 to run the electric vehicle 120 when higher amperage is desired quickly, such as when the electric vehicle 120 is moving up a steep hill or is predicted to move up the hill based on predefined or predicted route. In other examples, switching may be performed to optimize discharge, as the discharge is typically faster for the supercapacitor top-off batteries 112 than the electrochemical battery 102. In a further example, switching from the electrochemical battery 102 to the supercapacitor top-off batteries 112 may be done to enhance the lifespan of the electrochemical battery 102, as the supercapacitor top-off batteries 112 can be charged millions of times before they start to degrade, whereas the electrochemical battery 102 may only allow 500 to 1,000 charging cycles.

The supercapacitor top-off module 104 may be configured to easily connect to the electric vehicle 120 using standard battery connections 126 and may utilize circuitry including a first electrical path 122 and a second electrical path 124. The circuit layout of the first electrical path 122 and the second electrical path 124 is one example of how switching could occur, but there could be many others depending upon how the supercapacitor top-off module 104 is designed. As illustrated in FIG. 1, the first electrical path 122 shows connections 126 between the electric vehicle 120 and electrochemical battery 102. The second electrical path 124 shows connections between electric vehicle 120 and a supercapacitor top-off controller 108, which, in turn, is electrically coupled to the supercapacitor top-off batteries 112 via internal circuitry (not shown). The connections 126 may be terminals (such as found in battery terminals) to connect the supercapacitor top-off module 104 into the system 100. One or more of the connections 126 may include or be associated with digitally controlled, high-powered relays (e.g., switches) to open or close the first and second electrical paths 122, 124. Suitable relays are available from TE Connectivity of Schaffhausen, Switzerland, among other suppliers. After switching, a generator 125 (e.g., alternator) of the electric vehicle 120 may recharge the electrochemical battery 102 via a third electrical path 127.

In one embodiment, the supercapacitor top-off module 104 further includes a switch and test module 106. The switch and test module 106 may include a current tester, which performs current (amperage) measurement in the first electrical path 122 to determine how much current is drawn through the electrochemical battery 102 and the electric vehicle 120. The switch and test module 106 may also include a current tester in the second electrical path 124 to determine how much current is drawn through the through the supercapacitor top-off batteries 112. As explained in greater detail below, the switch and test module 106 may be instructed to disconnect or connect the electrochemical battery 102 using a digitally controlled, high-powered relay. The switch and test module 106 may operate in milliseconds, such that switching will not disrupt the smooth operation of the electric vehicle 120.

The supercapacitor top-off module 104 may also include a supercapacitor top-off controller 108 and a base module 116. As described in greater detail below, the supercapacitor top-off controller 108 may switch between the electrochemical battery 102 and the supercapacitor top-off batteries 112. For example, in response to being executed by the base module 116, the supercapacitor top-off controller 108 may disconnect the first electrical path 122 by instructing the switch and test module 106 to disconnect the first electrical path 122 and to switch the supercapacitor top-off batteries 112 onto the second electrical path 124 using high-powered switching relays. While the first electrical path 122 is disconnected, the electrochemical battery 102 may still remain connected to the generator 125 via the third electrical path 127, such that the electrochemical battery 102 may be recharged while the supercapacitor top-off batteries 112 are powering the electric vehicle 120.

The supercapacitor top-off controller 108, when executed by the base module 116, also facilitates switching between the supercapacitor top-off batteries 112 and the electrochemical battery 102 by disconnecting the second electrical path 124 and then instructing the switch and test module 106 to connect the first electrical path 122 allowing the electrochemical battery 102 onto the first electrical path 122 to power the electric vehicle 120.

The supercapacitor top-off module 104 may include a controller 110, which may be embodied as a processor to execute instructions stored in a memory 114, such as a random-access memory or the like. The memory 114 may store the base module 116 described above, as well as various sub-modules. The controller 110 may allow read/write access to a database 118, which may be stored and/or buffered by the memory 114. The controller 110 allows for current measurements from the first electrical path 122 and/or the second electrical path 124 to be collected and stored (in real-time) in the database 118. The controller 110 may also controls the switching of the high-powered switching relay in the first and second electrical paths 122, 124, as the base module executes 116.

The base module 116 reads the database 118 and then executes the switch and test module 106. The switch and test module 106 may determine if an electric vehicle 120 is connected and/or if the electrochemical battery 102 is connected. The switch and test module 106 also reads the current (amperage) through the first electrical path 122 when the electric vehicle 120 runs. The base module 116 controls the switch and test module 106 and measures amperage flowing through both electrical paths 122, 124, which may be stored in the database 118. The base module 116 may then calculate a current use pattern using stored data from the database 118.

The base module 116 may then determine if the current use pattern requires the supercapacitor top-off batteries 112. If so, the base module 116 executes the supercapacitor top-off controller 108 to switch off the first electrical path 122 and turn on the second electrical path 124, connecting the supercapacitor top-off batteries 112 through the supercapacitor top-off controller 108 to the electric vehicle 120. The base module 116 also determines if the current use patterns require switching from the supercapacitor top-off batteries 112 back to the electrochemical battery 102. The base module 116 may also contain the charger module 130 that controls the operation of charger 128 when an external power source (not shown) is connected to the charger 128.

The database 118 may have pre-stored data related to various top-off/switching conditions, which may trigger switching between the electrochemical battery 102 and the supercapacitor top-off batteries 112 (or vice versa). In one embodiment, the database 118 may contain an amperage threshold for the electrochemical battery 102. Once the amperage threshold is reached, the supercapacitor top-off batteries 112 may be switched in. In another embodiment, database 118 may contain an current (amperage) spike threshold (indicating, for example, that the electrochemical battery 102 may need a short boost). Once the threshold is reached, the supercapacitor top-off batteries 112 may be switched in. In yet another embodiment, the database 118 may a low temperature threshold and/or temperature data from temperature sensors (not shown). If a threshold low temperature is detected, the supercapacitor top-off batteries 112 may be be switched in for a cold start.

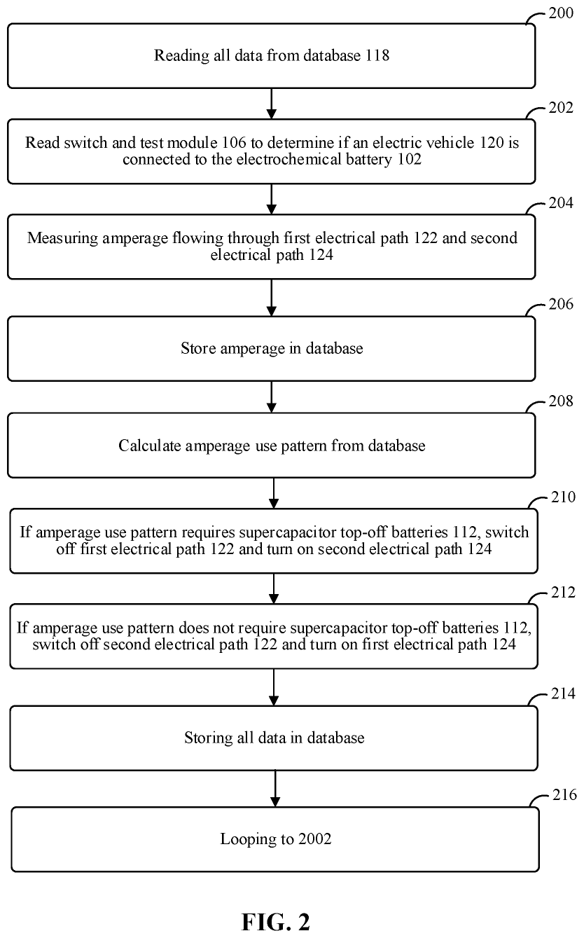

FIG. 2 is a flow chart of method performed by the base module 116. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

At step 200, the process begins with reading all data from the database 118. At step 202, the base module 116 reads the switch and test module 106 to determine if the electrochemical battery 102 is connected to the electric vehicle 102.

At step 204, the switch and test module 106, under control of the base module 116, measures the amperage passing through the first electrical path 122 (either inline or via a digital clamp meter) between the electrochemical battery 102 and the electric vehicle 120, as well as the amperage passing through the second electrical path 124 between the supercapacitor top-off batteries 112 and the electric vehicle 120 when the electric vehicle 120 is running. At step 206, the switch and test module 106 stores amperage data and associated time stamps for the amperage data in the database 118. The time stamps are used, in one embodiment, to determine power usage at various times and for predicting power usage by the electric vehicle 120 (e.g., generating a future load prediction).

At step 208, the base module 116 then calculates a current use pattern from the database 118. The current use pattern for the electrochemical battery 102 may be the average amps used per second, per hour, or another time interval. In some embodiments, the current use pattern of the electrochemical battery 102 could be the amperage data over time and/or compared to a threshold value or the current use pattern of a historical electrochemical battery 102 previously stored in the database 118. For example, the base module 116 may determine whether the current meets or exceeds a predefined, dynamic, and/or user-defined threshold value—or drops below a threshold value—which may be used as a condition to determine whether to switch between the electrochemical battery 102 and supercapacitor top-off batteries 112 (or vice versa).

In some embodiments, a switching threshold may be prestored in the database 118, such that if the current reaches the switching threshold, this data is used to switch from electrochemical battery 102 to supercapacitor top-off batteries 112. In one embodiment, the database 118 may contain an current/amperage threshold for the electrochemical battery 102, so that once the threshold is reached, the supercapacitor top-off batteries 112 will be switched in. In another embodiment, the database 118 may contain a current/amperage spike threshold (the electrochemical battery 102 may need a short boost) for the electrochemical battery 102, so that once the threshold is reached, the supercapacitor top-off batteries 112 will be switched in. In another embodiment, the database 118 may contain temperature data from temperature sensors. If a threshold minimum temperature is reached, the supercapacitor top-off batteries 112 will be switched in for a cold start.

At step 210, the base module 116 determines if the current use pattern requires the supercapacitor top-off batteries 112 to be switched in, i.e., the switching/top-off condition is satisfied. If so, the base module 116 instructs the supercapacitor top-off controller 108 to switch off the first electrical path 122 and turn on the second electrical path 124 connecting the supercapacitor top-off batteries 112 through supercapacitor top-off controller 108 to the electric vehicle 120.

At step 212, the base module 116 determines if the current use pattern does not require (or no longer requires) the supercapacitor top-off batteries 112. If the current use pattern does not require the supercapacitor top-off batteries 112, the base module 116 instructs the supercapacitor top-off controller 108 to switch on the first electrical path 122 and turn off the second electrical path 124 that connects the supercapacitor top-off batteries 112 through supercapacitor top-off controller 108 to electric vehicle 120. The base module 116 then stores all data in database 118 at step 214. At step 216, the base module 116 loops to step 202.

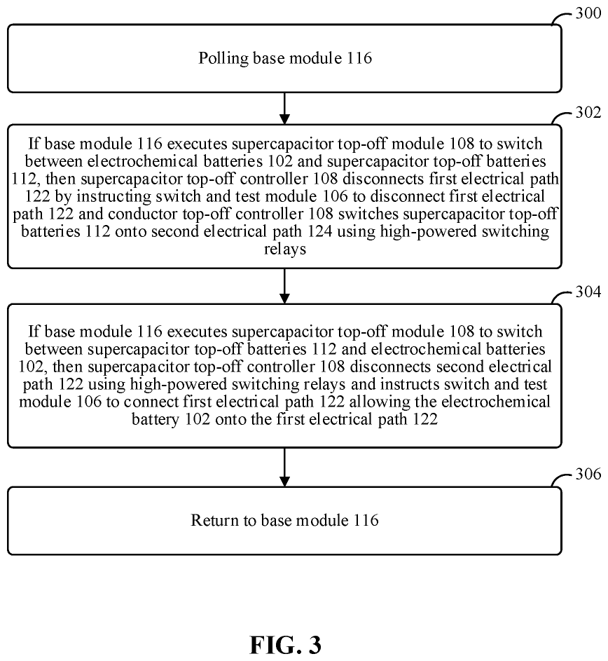

FIG. 3 is a flowchart of a method performed by the supercapacitor top-off controller 108 in an embodiment. Those skilled in the art will appreciate that, for this and other processes and methods disclosed herein, the functions performed in the processes and methods may be implemented in a differing order. Furthermore, the outlined steps and operations are only provided as examples. Some of the steps and operations may be optional, combined into fewer steps and operations, or expanded into additional steps and operations without detracting from the essence of the disclosed embodiments.

The process begins with the supercapacitor top-off controller 108 polling the base module 116 at step 300. At step 302, if the supercapacitor top-off controller 108 determines whether the base module 116 executes the supercapacitor top-off controller 108 to switch between the electrochemical battery 102 and the supercapacitor top-off batteries 112. If so, the supercapacitor top-off controller 108 disconnects the first electrical path 122 by instructing the switch and test module 106 to disconnect the first electrical path 122 via the high-powered switching relay and the supercapacitor top-off controller 108 switches the supercapacitor top-off batteries 112 onto the second electrical path 124 using the high-powered switching relays so that the electric vehicle 120 is powered by the supercapacitor top-off batteries 112.

At step 304, if the supercapacitor top-off controller 108 determines whether the base module 116 executes the supercapacitor top-off controller 108 to switch between the supercapacitor top-off batteries 112 and the electrochemical battery 102. If so, the supercapacitor top-off controller 108 disconnects the second electrical path 124 using a high-powered switching relay and then instructs the switch and test module 106 to connect the first electrical path 122 via a high-powered switching relay. This allows the electrochemical battery 102 onto the first electrical path 122 so that electric vehicle 120 is powered by the electrochemical battery 102. The supercapacitor top-off controller 108 then returns control to the base module 116 at step 306.

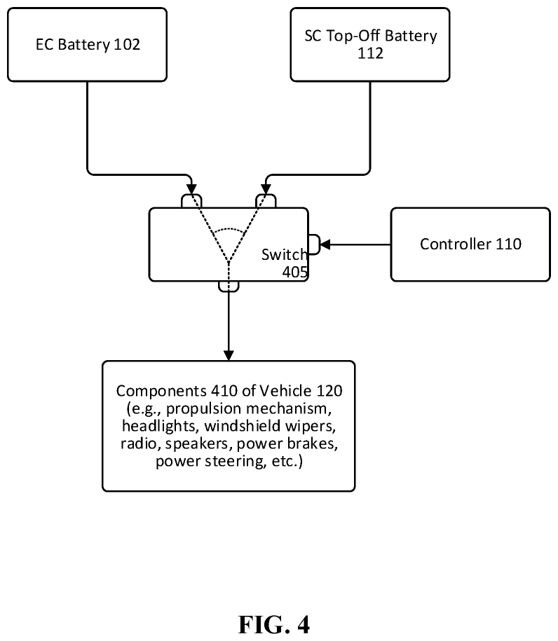

FIG. 4 is a block diagram illustrating a switch 405 controlled by controller 110 that toggles between a first configuration in which components 410 draw power from an electrochemical battery 102 and a second configuration in which the components 410 draw power from supercapacitor top-off batteries 112. The components 410 are components of an electric vehicle 120, such as a propulsion mechanism (e.g., engine and/or motor and/or other actuator), headlights, windshield wipers, radio, speakers, power brakes, power steering, display, camera, sensors, and the like. The first configuration is illustrated by a dashed line to the left, connecting the electrochemical battery 102 to the components 410, and disconnecting the supercapacitor top-off batteries 112 from the components 410. The second configuration is illustrated by a dashed line to the right, connecting the supercapacitor top-off batteries 112 to the components 410, and disconnecting the electrochemical battery 102 from the components 410. The toggling of the switch 405 between the two configurations can be controlled by the controller 110 shown in FIG. 1. The switch 405 can be a mechanical switch, a Single Pole Single Throw (SPST) switch, a Single Pole Double Throw (SPDT) switch, a Double Pole Single Throw (DPST) switch, a Double Pole Double Throw (DPDT) switch, a toggle switch, a transistor switch, an NPN transistor switch, a PNP transistor switch, an H-bridge switch, a relay, or a combination thereof

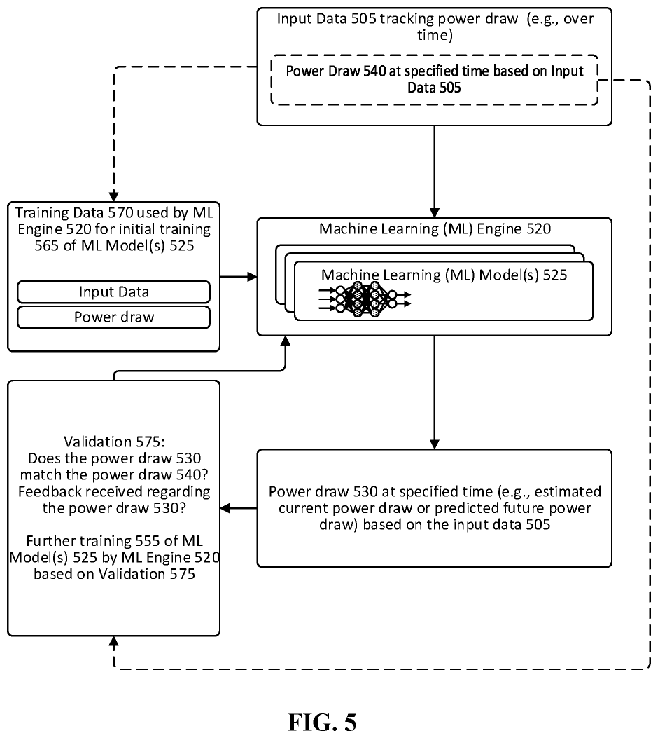

FIG. 5 is a block diagram 500 illustrating use of one or more trained machine learning models 525 of a machine learning engine 520 to identify a power draw 530 (e.g., current usage pattern) to estimate a current power draw or predict a future power draw. The ML engine 520 and/or the ML model(s) 525 can include one or more neural network (NNs), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more conditional generative adversarial networks (cGANs), one or more other types of neural networks, one or more trained support vector machines (SVMs), one or more trained random forests (RFs), one or more computer vision systems, one or more deep learning systems, one or more classifiers, one or more transformers, or combinations thereof. Within FIG. 5, a graphic representing the trained ML model(s) 525 illustrates a set of circles connected to another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. The ML engine 520 and/or the ML model(s) 525 can be part of the AI/ML module 182.

Once trained via initial training 565, the one or more ML models 525 receive, as an input, input data 505 that identifies power draw by various components and/or subsystems of a system (e.g., of the electric vehicle 120), for instance tracking power draw by various components and/or subsystems of the system (e.g., of the electric vehicle 120) over time. In some examples, the input data 505 identifies attribute(s) of charging and/or discharging of the electrochemical battery 102 and/or the supercapacitor top-off batteries 112 (e.g., type, voltage, discharge curve, capacitance, impedance, current, amperage, capacity, energy density, specific energy density, power density, temperature, temperature dependence, service life, physical attributes, charge cycle, discharge cycle, cycle life, deep discharge ability, discharge rate, charge rate, and the like), attribute(s) of the components and/or subsystems of the system that draw charge from the electrochemical battery 102 and/or the supercapacitor top-off batteries 112, attribute(s) of the system that includes the electrochemical battery 102 and/or the supercapacitor top-off batteries 112 and draws charge from the electrochemical battery 102 and/or the supercapacitor top-off batteries 112 (e.g., mileage, efficiency, ergonomics, aerodynamics, shape, geometry, weight, horsepower, brake power, turning radius, type, size, energy consumption rate, location, speed, velocity, acceleration, deceleration, turning radius, and the like), or a combination thereof.

At least some of the input data 505 may be received from one or more sensors, such as sensors to measure voltage, current, resistance, capacitance, inductance, frequency, power, temperature, continuity, location, motion, acceleration, deceleration, orientation, changes to any of these attributes, or a combination thereof. In some examples, the one or more sensors can include one or more voltmeters, ammeters, ohmmeters, capacimeters, inductance meters, wattmeters, thermometers, thermistors, multimeters, accelerometers, gyrometers, gyroscopes, global navigation satellite system (GNSS) receivers, inertial measurement units (IMUs), or a combination thereof. In some examples, the input data 505 may be received from a one or more databases, such as the database 118, where at least some of the input data 505 may be stored after measurement by the sensors. In some examples, the input data 505 can also include information that is indicative of total capacity of the electrochemical battery 102 and/or the supercapacitor top-off batteries 112, the remaining charge and/or remaining capacity of the electrochemical battery 102 and/or the supercapacitor top-off batteries 112, a level of shade or shadows that could prevent solar cells from generating charge from light (e.g., whether or not shade or shadows are blocking solar cells to prevent solar charging), a route of the vehicle, a schedule trip of the vehicle, elevation data indicative of uphill and/or downhill portions of a route of the vehicle, or a combination thereof. In some examples, for instance during validation 575, the ML engine 520 and/or the one or more ML models 525 can also receive, as an additional input, a predetermined power draw 540 (e.g., current power draw or predicted future power draw)that is based on (or otherwise corresponds to) the input data 505. In response to receiving at least the input data 505 as an input(s), the one or more ML model(s) 525 estimate the power draw 530 (e.g., current power draw or predicted future power draw) based on the input data 505. The power draw 530 (e.g., current power draw or predicted future power draw) can indicate an amount of power drawn, a rate at which power is drawn, and the like. The power draw can be indicated in terms of voltage, current, resistance, capacitance, inductance, frequency, power, amperage, capacity, energy density, specific energy density, power density, charge cycle, discharge cycle, cycle life, deep discharge ability, discharge rate, charge rate, or a combination thereof. The power draw can be indicated in units of watts, amps, volts, ohms, joules, farads, henries, any of the previously-listed units measured per distance or area (e.g., per meter or per meter squared), any of the previously-listed units measured per unit of time (e.g., per second or per second squared), or a combination thereof.

Once the one or more ML models 525 identify the power draw 530, the power draw 530 can be output to an output interface that can indicate the power draw 530 to a user (e.g., by displaying the power draw 530 or playing audio indicative of the power draw 530) and/or to the hybrid power system 100 which can adjust settings and/or configurations for the hybrid power system 100, for instance to switch between a first configuration in which components and/or subsystems (e.g., the propulsion system of the vehicle) draw power from an electrochemical battery (and disconnects a supercapacitor from providing power to those components and/or subsystems) and a second configuration in which the components and/or subsystems (e.g., the propulsion system of the vehicle) draw power from an supercapacitor (and disconnects the electrochemical battery from providing power to those components and/or subsystems).

Before using the one or more ML models 525 to identify the power draw 530 the ML engine 520 performs initial training 565 of the one or more ML models 525 using training data 570. The training data 570 can include examples of input data tracking power draw over time (e.g., as in the input data 505) and/or examples of a pre-determined power draw (e.g., as in the pre-determined power draw 540). In some examples, the pre-determined power draw in the training data 570 are power draw(s) that the one or more ML models 525 previously identified based on the input data in the training data 570. In the initial training 565, the ML engine 520 can form connections and/or weights based on the training data 570, for instance between nodes of a neural network or another form of neural network. For instance, in the initial training 565, the ML engine 520 can be trained to output the pre-determined power draw in the training data 570 in response to receipt of the corresponding input data in the training data 570.

During a validation 575 of the initial training 565 (and/or further training 555), the input data 505 (and/or the exemplary input data in the training data 570) is input into the one or more ML models 525 to identify the power draw 530 as described above. The ML engine 520 performs validation 575 at least in part by determining whether the identified power draw 530 matches the pre-determined power draw 540 (and/or the pre-determined power draw in the training data 570). If the power draw 530 matches the pre-determined power draw 540 during validation 575, then the ML engine 520 performs further training 555 of the one or more ML models 525 by updating the one or more ML models 525 to reinforce weights and/or connections within the one or more ML models 525 that contributed to the identification of the power draw 530, encouraging the one or more ML models 525 to make similar power draw determinations given similar inputs. If the power draw 530 does not match the pre-determined power draw 540 during validation 575, then the ML engine 520 performs further training 555 of the one or more ML models 525 by updating the one or more ML models 525 to weaken, remove, and/or replace weights and/or connections within the one or more ML models that contributed to the identification of the power draw 530, discouraging the one or more ML models 525 from making similar power draw determinations given similar inputs.

Validation 575 and further training 555 of the one or more ML models 525 can continue once the one or more ML models 525 are in use based on feedback 550 received regarding the power draw 530. In some examples, the feedback 550 can be received from a user via a user interface, for instance via an input from the user interface that approves or declines use of the power draw 530 for charging. In some examples, the feedback 550 can be received from another component or subsystem of the hybrid power system 100, for instance based on whether the component or subsystem successfully uses the power draw 530, whether use the power draw 530 causes any problems for the component or subsystem (e.g., which may be detected using the sensors), whether use the power draw 530 are accurate, or a combination thereof. If the feedback 550 is positive (e.g., expresses, indicates, and/or suggests approval of the power draw 530, success of the power draw 530, and/or accuracy the power draw 530), then the ML engine 520 performs further training 555 of the one or more ML models 525 by updating the one or more ML models 525 to reinforce weights and/or connections within the one or more ML models 525 that contributed to the identification of the power draw 530, encouraging the one or more ML models 525 to make similar power draw determinations given similar inputs. If the feedback 550 is negative (e.g., expresses, indicates, and/or suggests disapproval of the power draw 530, failure of the power draw 530, and/or inaccuracy of the power draw 530) then the ML engine 520 performs further training 555 of the one or more ML models 525 by updating the one or more ML models 525 to weaken, remove, and/or replace weights and/or connections within the one or more ML models that contributed to the identification of the power draw 530, discouraging the one or more ML models 525 to make similar power draw determinations given similar inputs.

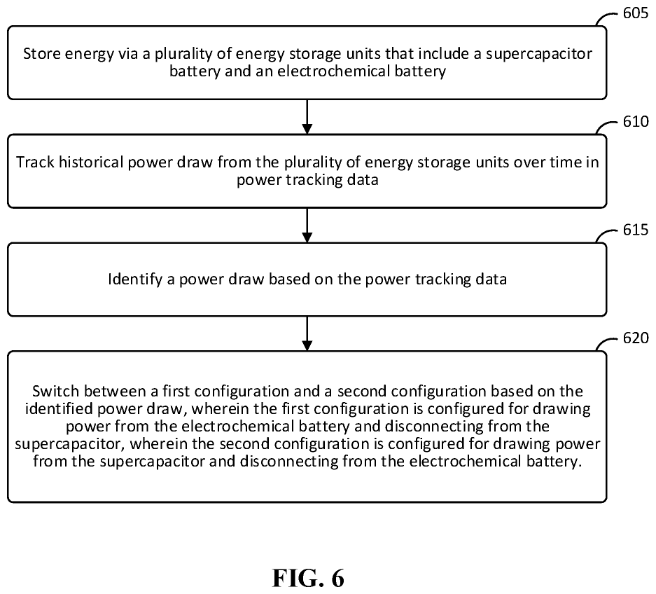

FIG. 6 is a flow diagram illustrating a method 600 for energy management. The components that perform the method 600 can include the hybrid power system 100, the electrochemical battery 102, the supercapacitor top-off module 104, the switch and test module 106, the supercapacitor top-off controller 108, the controller 110, the supercapacitor top-off batteries 112, the memory 114, the base module 116, the database 118, electric vehicle 120, any system(s) that perform any of the processes of any of the preceding figures, the switch 405, the components 410, the ML engine 520 of FIG. 5, an apparatus, a non-transitory computer-readable storage medium coupled to a processor, component(s) or subsystem(s) of any of these systems, or a combination thereof.

At operation 605, the controller is configured to, and can, store energy via a plurality of energy storage units that include a supercapacitor and an electrochemical battery. At operation 610, the controller is configured to, and can, track historical power draw from a plurality of energy storage units, such as the electrochemical battery 102 and/or supercapacitor top-off batteries 112, over time in power tracking data.

In some examples, the controller includes a charge management database that is configured to store the power tracking data that tracks the historical power draw from the plurality of energy storage units over time.

At operation 615, the controller is configured to, and can, identify a power draw based on the power tracking data.

In some examples, the controller is configured to, and can, add (e.g., using the supercapacitor top-off module 104) a plurality of power draw values corresponding to a plurality of components that are configured to draw power (e.g., a propulsion mechanism, a set of headlights, a set of windshield wipers, a radio, a set of speakers, a display, a navigation system, a power steering system, a powered brake system, and the like) to identify the power draw based on the power tracking data. In some examples, the controller 110 is configured to, and can, identify the plurality of power draw values corresponding to the plurality of components based on the power tracking data (e.g., as measured by sensor(s) and/or stored in the database 118). In some examples, the power tracking data can track the power draw values for each of the components over time. In some examples, the power tracking data can track the total power draw of all of the components over time. In some examples, the controller 110 is configured to, and can, identify the plurality of power draw values corresponding to the plurality of components based on one or more measurements from one or more sensors.

In some examples, the controller 110 is configured to, and can, input the power tracking data (e.g., as part of the input data 505) into a trained machine learning model (e.g., the ML model(s) 525) to identify the power draw (e.g., as power draw 530). In some examples, the controller 110 is configured to, and can, also input information tracking charging of the plurality of energy storage units over time, and/or usage of the different components of the vehicle over time (e.g., as another part of the input data 505), into the trained machine learning model to identify the power draw. In some examples, the controller 110 is configured to, and can, use the identified power draw (e.g., the power draw 530) as training data to update the trained machine learning model (e.g., as in the further training 555 and/or the initial training 565).

At operation 620, the controller 110 is configured to, and can, switch between a first configuration and a second configuration based on the identified power draw. The first configuration is configured for drawing power from the electrochemical battery 102 and disconnecting from the supercapacitor top-off batteries 112. The second configuration is configured for drawing power from the supercapacitor top-off batteries 112 and disconnecting from the electrochemical battery 102.

In some examples, to switch between the first configuration and the second configuration, the controller 110 is configured to switch from the first configuration to the second configuration based on the identified power draw exceeding a threshold power draw. For instance, because the supercapacitor top-off batteries 112 can provide power at a faster rate than the electrochemical battery 102, if power needs to be provided at a rate that exceeds the threshold power draw, the controller 110 can switch to the second configuration that draws power from the supercapacitor top-off batteries 112 rather than the electrochemical battery 102.

In some examples, to switch between the first configuration and the second configuration, the controller 110 is configured to switch from the second configuration to the first configuration based on the identified power draw falling below a threshold power draw. For instance, if power no longer needs to be provided at a rate that exceeds the threshold power draw, the controller 110 can switch to the first configuration that draws power from the electrochemical battery 102 rather than the supercapacitor top-off batteries 112, as the electrochemical battery 102 can provide more steady power more efficiently than the supercapacitor top-off batteries 112. By switching between the two, the controller 110 can provide the benefits of both the supercapacitor top-off batteries 112 and the electrochemical battery 102 while mitigating the downsides of both the supercapacitor top-off batteries 112 and the electrochemical battery 102.

In some examples, the controller 110 is configured to, and can, provide the power draw from at least one of the plurality of energy storage units after switching between the first configuration and the second configuration.

In some examples, the controller 110 includes a switch (e.g., of the switch and test module 106). To switch between the first configuration and the second configuration, the controller 110 can toggle the switch, wherein a first contact of the switch is coupled to one or more components that draw charge from one or more of the plurality of energy storage units, wherein a second contact of the switch is coupled to the electrochemical battery in the first configuration, wherein the second contact of the switch is coupled to the supercapacitor in the second configuration. In some examples, to switch between the two configurations, the controller 110 can toggle the switch between two paths for electricity to flow, such as the first electrical path 122 and the second electrical path 124.

In some examples, the controller 110 includes an output interface that is configured to, and can, output an indication of the power draw, and/or output an indication of a current configuration after the switching of operation 620 (the current configuration being the first configuration, the second configuration, or a third configuration not previously discussed).

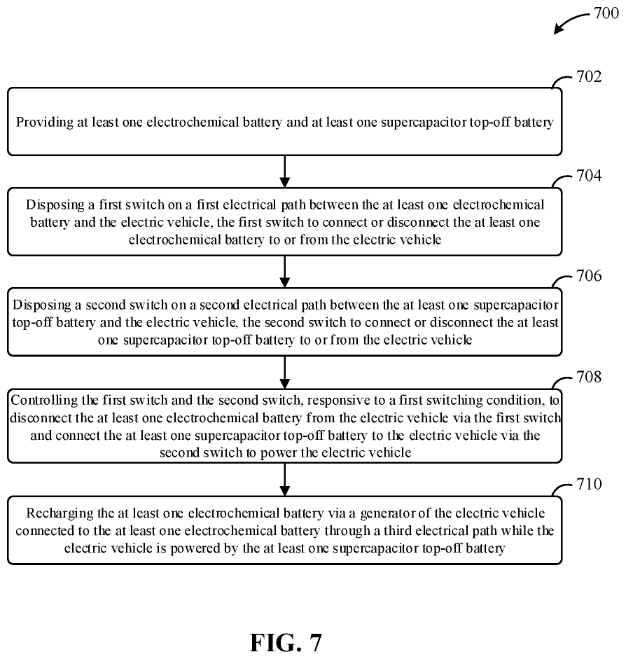

FIG. 7 is a flowchart of a method 700 for powering an electric vehicle 120. The components that perform the method 700 can include the hybrid power system 100, the electrochemical battery 102, the supercapacitor top-off module 104, the switch and test module 106, the supercapacitor top-off controller 108, the controller 110, the supercapacitor top-off batteries 112, the memory 114, the base module 116, the database 118, electric vehicle 120, any system(s) that perform any of the processes of any of the preceding figures, the switch 405, the components 410, the ML engine 520 of FIG. 5, an apparatus, a non-transitory computer-readable storage medium coupled to a processor, component(s) or subsystem(s) of any of these systems, or a combination thereof.

At step 702, the method 700 begins by providing at least one electrochemical battery 102 and at least one supercapacitor top-off battery 122. At step 704, the method 700 continues by disposing a first switch on a first electrical path 122 between the at least one electrochemical battery 102 and the electric vehicle 120, the first switch to connect or disconnect the at least one electrochemical battery 102 to or from the electric vehicle 120. At step 706, the method 700 continues by disposing a second switch on a second electrical path 124 between the at least one supercapacitor top-off battery 112 and the electric vehicle 120, the second switch to connect or disconnect the at least one supercapacitor top-off battery 122 to or from the electric vehicle 120.

At step 708, the method 700 continues controlling the first switch and the second switch, responsive to a first switching condition, to disconnect the at least one electrochemical battery 102 from the electric vehicle 120 via the first switch and connect the at least one supercapacitor top-off battery 112 to the electric vehicle via the second switch to power the electric vehicle 120.

At step 710, the method 700 continues by recharging the at least one electrochemical battery 102 via a generator 125 of the electric vehicle 120 connected to the at least one electrochemical battery 102 through a third electrical path 127 while the electric vehicle 120 is powered by the at least one supercapacitor top-off battery 112.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional operations not included in a figure. A process may correspond to a method, a function, a procedure, a subroutine, a subprogram, etc. When a process corresponds to a function, its termination can correspond to a return of the function to the calling function or the main function.

Aspects of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other types of media/machine-readable medium suitable for storing electronic instructions (e.g., computer programming code, such as software or firmware). Moreover, aspects of the present disclosure may also be downloaded as one or more computer program products, wherein the program may be transferred from a remote computer to a requesting computer by way of data signals embodied in a carrier wave or other propagation medium via a communication link (e.g., a modem or network connection).

What is claimed is:

1. A system for powering an electric vehicle, the system comprising:
at least one electrochemical battery;
at least one supercapacitor top-off battery;
a first switch disposed on a first electrical path between the at least one electrochemical battery and the electric vehicle, the first switch to connect or disconnect the at least one electrochemical battery to or from the electric vehicle;
a second switch disposed on a second electrical path between the at least one supercapacitor top-off battery and the electric vehicle, the second switch to connect or disconnect the at least one supercapacitor top-off battery to or from the electric vehicle; and
a controller communicatively coupled to the first switch and the second switch, wherein the controller, responsive to a first switching condition, disconnects the at least one electrochemical battery from the electric vehicle via the first switch and connects the at least one supercapacitor top-off battery to the electric vehicle via the second switch to power the electric vehicle,
wherein the at least one electrochemical battery is coupled to an generator of the electric vehicle via a third electrical path, such that the at least one electrochemical battery is recharged by the generator while the electric vehicle is powered by the at least one supercapacitor top-off battery.

2. The system of claim 1, further comprising at least one current tester disposed on one or more of the first electrical path or the second electrical path, the at least one current tester to measure current flow between the at least one electrochemical battery or the at least one supercapacitor top-off battery, respectively, and the electric vehicle.

3. The system of claim 2, wherein the first switching condition comprises the current flow meeting or exceeding a threshold value.

4. The system of claim 2, wherein the first switching condition comprises a current spike meeting or exceeding a threshold value.

5. The system of claim 2, further comprising a database to store real-time measurements of the current flow from the at least one current tester.

6. The system of claim 5, wherein the controller calculates a current use pattern for one or both of the at least one electrochemical battery or the at least one supercapacitor top-off battery based on the real-time measurements of the current flow.

7. The system of claim 6, wherein the first switching condition comprises a future load prediction based on the current use pattern exceeding an amount of charge remaining in one or both of the at least one electrochemical battery or the at least one supercapacitor top-off battery.

8. The system of claim 7, wherein the future load prediction is obtained from machine learning according to historical current use patterns.

9. The system of claim 1, wherein the first switching condition comprises a temperature of the electric vehicle dropping below a low temperature threshold.

10. The system of claim 1, wherein the controller, responsive to second switching condition, disconnects the at least one supercapacitor top-off battery from the electric vehicle via the second switch and reconnects the at least one electrochemical battery to the electric vehicle via the first switch.

11. A method for powering an electric vehicle, the method comprising:
providing at least one electrochemical battery and at least one supercapacitor top-off battery;
disposing a first switch on a first electrical path between the at least one electrochemical battery and the electric vehicle, the first switch to connect or disconnect the at least one electrochemical battery to or from the electric vehicle;
disposing a second switch on a second electrical path between the at least one supercapacitor top-off battery and the electric vehicle, the second switch to connect or disconnect the at least one supercapacitor top-off battery to or from the electric vehicle;
controlling the first switch and the second switch, responsive to a first switching condition, to disconnect the at least one electrochemical battery from the electric vehicle via the first switch and connect the at least one supercapacitor top-off battery to the electric vehicle via the second switch to power the electric vehicle; and
recharging the at least one electrochemical battery via a generator of the electric vehicle connected to the at least one electrochemical battery through a third electrical path while the electric vehicle is powered by the at least one supercapacitor top-off battery.

12. The method of claim 11, further comprising measuring current flow between the at least one electrochemical battery or the at least one supercapacitor top-off battery and the electric vehicle.

13. The method of claim 12, wherein the first switching condition comprises the current flow meeting or exceeding a threshold value.

14. The method of claim 12, wherein the first switching condition comprises a current spike meeting or exceeding a threshold value.

15. The method of claim 12, further comprising storing real-time measurements of the current flow in a database.

16. The method of claim 15, further comprising calculating a current use pattern for one or both of the at least one electrochemical battery or the at least one supercapacitor top-off battery based on the real-time measurements of the current flow.

17. The method of claim 16, wherein the first switching condition comprises a future load prediction based on the current use pattern exceeding an amount of charge remaining in one or both of the at least one electrochemical battery or the at least one supercapacitor top-off battery.

18. The method of claim 17, further comprising using machine learning based on historical current use patterns to obtain the future load prediction.

19. The method of claim 11, wherein the first switching condition comprises a temperature of the electric vehicle dropping below a low temperature threshold.

20. The method of claim 11, further comprising controlling, responsive to second switching condition, the first switch and the second switch to disconnect the at least one supercapacitor top-off battery from the electric vehicle via the second switch and reconnect the at least one electrochemical battery to the electric vehicle via the first switch.
